(19) United States
(12) Patent Application Publication
(10) Pub. No.: US 2006/0071434 A1
(43) Pub. Date: Apr. 6, 2006

(54) Connecting structure of a front wheel and a frame of a golf cart

(76) Inventor: Ying-Hsiung Cheng, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/957,716

(22) Filed: Oct. 5, 2004

(51) Int. Cl. B62B 1/00

(52) U.S. Cl. 280/47.26

(57) ABSTRACT

A golf cart includes a frame, a first connecting member secured to a lower end of the frame, a front wheel support, a front wheel supported on the support, and a second connecting member connected to the wheel support; the first connecting member has two lateral protrusions, a stick secured to the protrusions at two ends, and a rib projecting out from between the protrusions; the second connecting member has two hooked elements, and a pivotal plate on a top, which has a hooked portion at a rear end; a spring is connected to the plate for biasing the rear end of the plate downwards; the second member can be detachably connected to the first member to hold the wheel support on the lower end of the frame with the hooked elements being hooked over the stick, and with the hooked portion of the plate being hooked over the rib.

### BACKGROUND OF THE INVENTION

1. Field of the Invention

The present invention relates to a golf cart, more particularly one, which includes a frame, a first connecting member secured on a lower end of the frame, a support, a front wheel supported on the support, a second connecting member; the second connecting member is secured to the support, and can be detachably joined to the first connecting member such that the front wheel and the support can be easily removed from the frame for the golf cart to occupy less space when the cart isn't used.

2. Brief Description of the Prior Art

Conventionally, golf carts have front wheels supported on support members, which are secured on lower ends of frames. And, support members of conventional folding golf carts, on which front wheels are supported, can only be angularly displaced between in-use position and not-in-use one, and can't be easily and rapidly separated from the frames. In other words, without use of a tool, the front wheels of conventional golf carts, including foldable ones, can't be removed from the frames for allowing repair to be carried out thereon more easily. And, the front wheels of conventional golf carts can't be rapidly separated from the frames for the golf carts to occupy less space when the golf carts are not in use.

### SUMMARY

It is a main object of the present invention to provide an improvement on a golf cart to overcome the above disadvantages.

The golf cart of the present invention includes a frame, a first connecting member secured to a lower end of the frame, a front wheel support, a front wheel supported on the support, and a second connecting member connected to the wheel support. The first connecting member has two lateral protrusions, a stick secured to the protrusions at two ends, and a rib projecting out from between the protrusions. The second connecting member has two hooked elements, a pivotal plate on a top, and a spring for biasing the rear end of the plate downwards; the plate has a hooked portion at a rear end thereof. Thus, the second connecting member can be detachably connected to the first connecting member to secure the wheel support on the lower end of the frame with the hooked elements being hooked over the stick, and with the hooked portion of the plate being hooked over and engaged with the rib.

### BRIEF DESCRIPTION OF THE DRAWINGS

The present invention will be better understood by referring to the accompanying drawings, wherein:

FIG. 1 is a side view of the golf cart in the present invention,

FIG. 2 is a partial exploded perspective view of the golf cart according to the present invention,

FIG. 3 is partial perspective view of the golf cart according to the present invention,

FIG. 4 is a partial vertical cross-sectional view of the golf cart in the present invention,

FIG. 5 is a partial vertical cross-sectional view of the present golf cart with the front wheel being removed from the frame,

FIG. 6 is a view of the present golf cart, in the folded position and with the front wheel separated from the first connecting member,

FIG. 7 is a partial rear perspective view of the present golf cart, while the front wheel is being connected to the clamping member, and

FIG. 8 is a partial front perspective view of the present golf cart, with the front wheel being held in position by the clamping member.

### DETAILED DESCRIPTION OF THE PREFERRED EMBODIMENTS

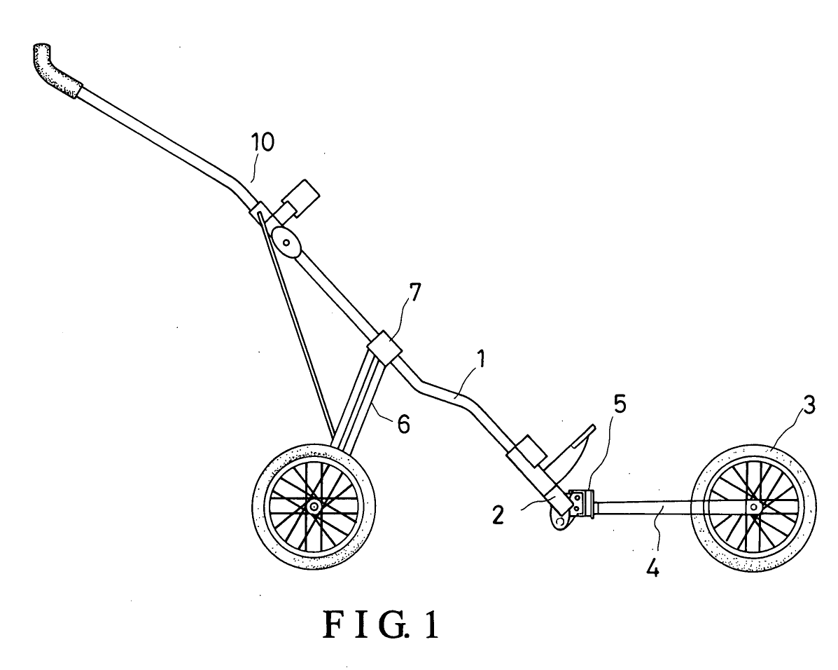

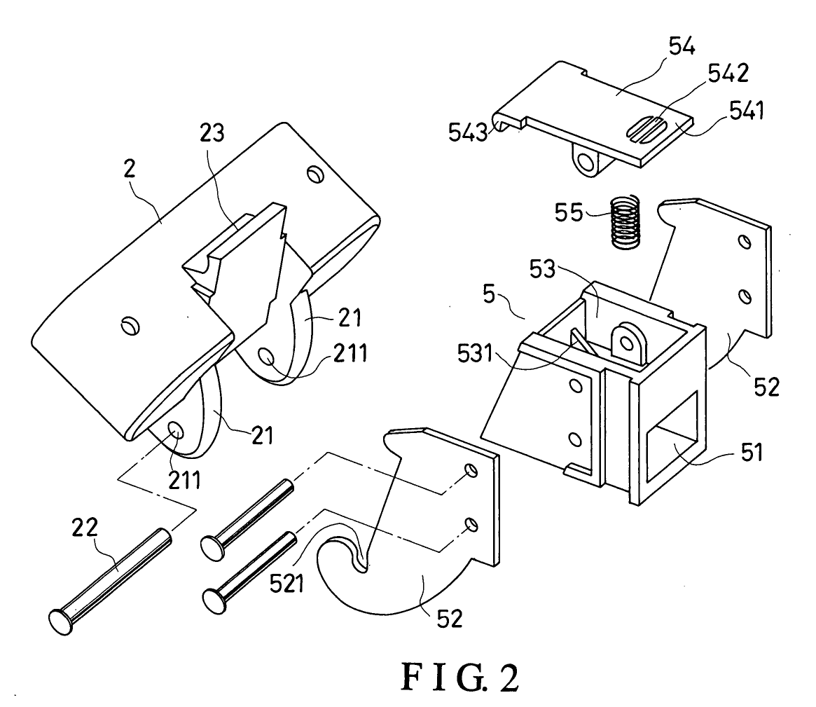

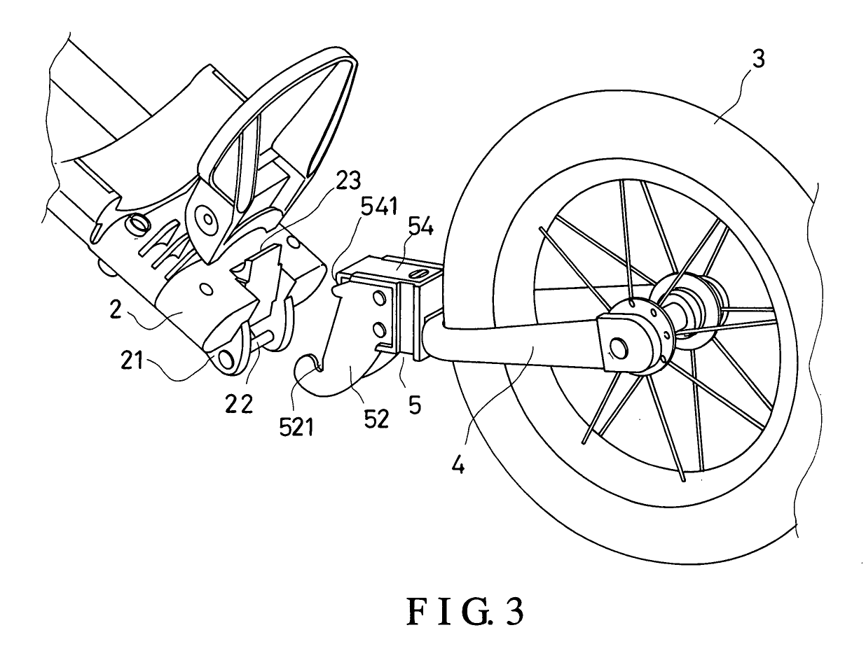

Referring to FIGS. 1 to 4, a preferred embodiment 10 of a golf cart in the present invention includes a frame, a first connecting members 2, a front wheel 3, a front wheel support 4, a second connecting member 5, two rear wheel supports 6, and a third connecting member 7, which frame includes two main support rods 1.

The first connecting member 2 is secured to lower ends of the main support rods 1, and it is formed with two apart connecting protrusions 21, and an engaging rib 23 projecting upwards from between the connecting protrusions 21. The connecting protrusions 21 have fitting holes 211, and an engaging stick 22 is passed into, and secured to the connecting protrusions 21 at two ends thereof.

The second connecting member 5 has a connecting cavity 51, two hooked elements 52 respectively secured on lateral sides thereof, a holding room 53 on an upper end, a pivotal engaging plate 54 over a top of the holding room 53, and an elastic element 55 connected to the pivotal plate 54 for biasing a rear end of the pivotal plate 54 downwards. Each of the hooked elements 52 has an upward hook portion 521. The pivotal engaging plate 54 has a front end 541 for exerting force on, an anti-slip surface 542 on an upper side of the front end 541, and a hooked portion 543 on the rear end thereof, which rear end projects out beyond a rear end of the holding room 53; thus, the rear hooked portion 543 will move to a higher position when the user presses the front end 541. In addition, strengthening ribs 531 are formed for strengthening those portions of the second connecting member 5 that are around the holding room 53.

The front wheel 3 is connected to a fork portion of the front wheel support 4 at an axle thereof. And, the front wheel support 4 is held in and secured to the connecting cavity 51 of the second connecting member 5 at a rear end thereof.

The third connecting member 7 is arranged near to middles of the main support rods 1 while the front wheel supports 6 are pivoted to the third connecting member 7 at upper ends. Furthermore, a hanging stick 71 is secured to a back of the third connecting member 7 at two ends in a substantially horizontal position.

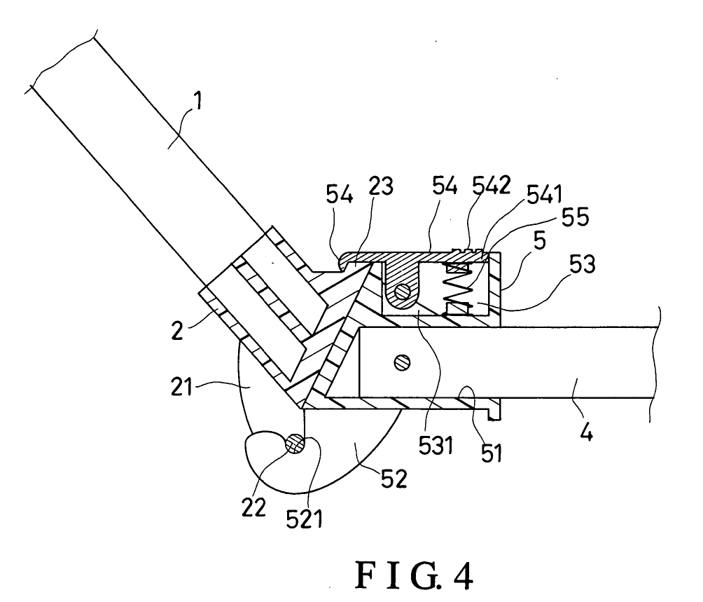

Referring to FIG. 4, the hooked elements 52 of the second connecting member 5 are hooked over the engaging stick 22, and the hooked portion 543 of the pivotal plate 53 hooked over the engaging rib 23 such that the front wheel support 4 is securely held at the lower ends of the main support rods 1, allowing the front wheel 3 to function.

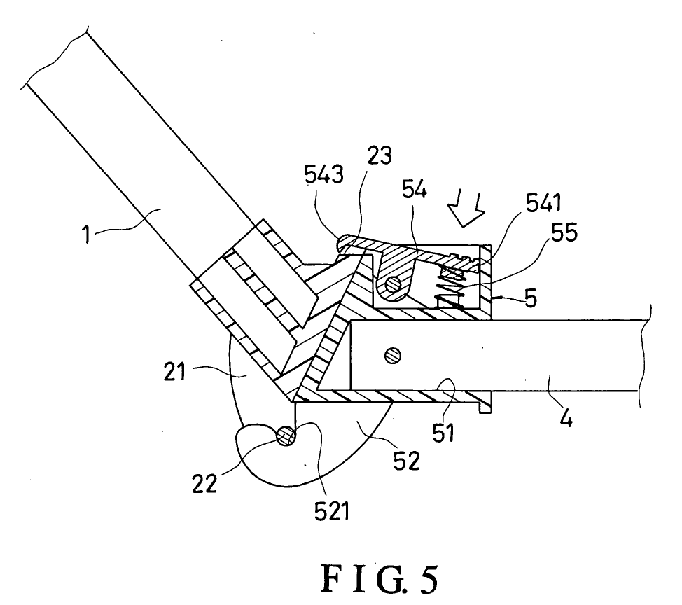

Referring to FIG. 5, the user presses the front end 541 of the pivotal plate 54 such that the hooked portion 543 of the pivotal plate 54 moves up and separates from the engaging rib 23, and the front wheel 3 and the wheel support 4 can be removed from the lower ends of the main support rods 1, i.e. the in-use position.

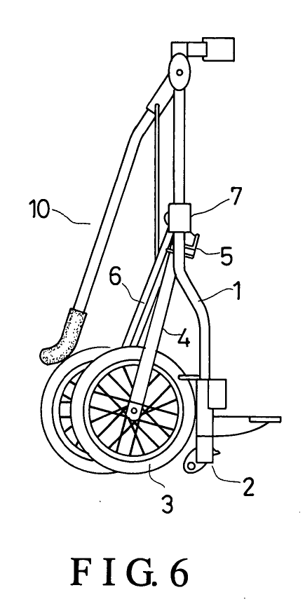

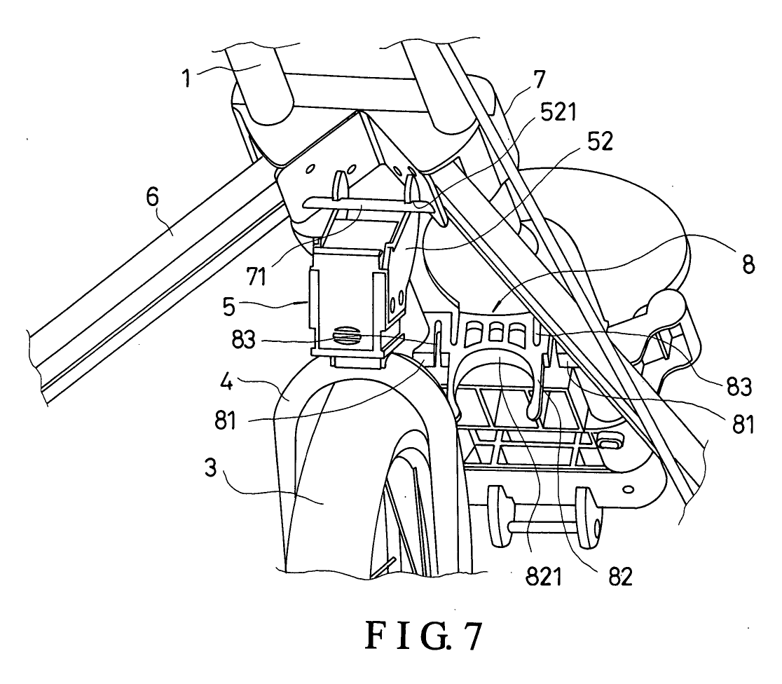

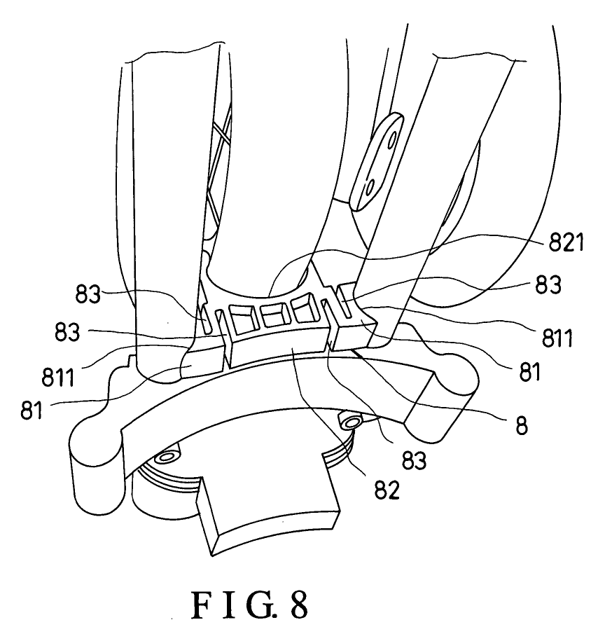

Furthermore, referring to FIGS. 6, 7, and 8, a clamping member 8 is connected to the main support rods 1 above the first connecting member 2 for helping hold the front wheel 3 and the wheel support 4 in position after the second connecting member 5 has been separated from the first connecting member 2, and the front wheel 3, the wheel support 4, and the connecting member 5 together removed from the lower ends of the main support rods 1. The clamping member 8 has fitting parts 81 at lateral sides, and a clamping part 82 between the fitting parts 81; each fitting part 81 has an engaging cavity 811, which is fitted on a respective one of the main support rods 1. The clamping part 82 has a rearwards facing holding space 821 in the middle for the front wheel 3 to be fitted in. Before the front wheel 3 is fitted in the clamping part 82, the second connecting member 5 is hooked over the hanging stick 71 at the hook portions 521 thereof; thus, the front wheel 3 and the wheel support 4 can be held steady when they are not used. Furthermore, elongate gaps 83 are formed between the clamping part 82 and the fitting parts 81 such that the clamping member 8 can be resiliently narrowed by means of exerting force on the fitting parts 81.

From the above description, it can be easily understood that the golf cart has advantages as followings:

1. When the golf cart is not used, the front wheel and the front wheel support can be separated from the main support rods for the golf cart to occupy less space in storage.

2. Because the front wheel can be removed from the main support rods of the golf cart, the user can use the golf cart without the front wheel according to his need.

3. The second connecting member 5 can be easily secured to and separated from the first connecting member 1 with use of any tool therefore the front wheel is convenient to use.

4. The front wheel can be easily removed from the main support rods for replacement and for repair to be easily carried out thereon.

What is claimed is:

1. A golf cart, comprising
a frame including two main support rods;
a first connecting member secured to lower ends of the main support rods; the first connecting member having two apart connecting protrusions, and an engaging stick secured to the connecting protrusions at two ends; the first connecting member having an engaging rib projecting out from between the connecting protrusions;
a front wheel support;
a front wheel supported on the front wheel support; and
a second connecting member securely joined to the front wheel support; the second connecting member having two hooked elements on lateral sides thereof; the second connecting member having a holding room on an upper end, and a pivotal engaging plate over a top of the holding room; each of the hooked elements having a hook portion; the pivotal engaging plate having a first end for exerting force on, and a hooked portion on a second end thereof, which second end projects out beyond a rear end of the holding room;
the second connecting member being capable of being separably connected to the first connecting member with the hook portions of the hooked elements being hooked over the engaging stick, and with the hooked portion of the pivotal plate being hooked over the engaging rib, thus securing the front wheel support on the lower ends of the main support rods of the frame.

2. The golf cart as claimed in claim 1, wherein the second connecting member has a connecting cavity, and the front wheel support is passed into and secured to the connecting cavity.

3. The golf cart as claimed in claim 1, wherein the pivotal engaging plate of the second connecting member has an anti-slip surface on an upper side of the first end thereof.

4. The golf cart as claimed in claim 1, wherein an elastic element is connected to the pivotal engaging plate of the second connecting member for biasing the second end of the plate downwards.

5. The golf cart as claimed in claim 1, wherein
a hanging stick is securely positioned near to middles of the main support rods, and a clamping member is connected to the main support rods;
the clamping member having two fitting parts at lateral sides, which are formed with engaging cavities, and fitted on respective ones of the main support rods at the engaging cavities; the clamping member having a clamping part between the fitting parts, which has a holding space in a middle for the front wheel to be fitted in; the clamping member having a plurality of gaps between the clamping part and the fitting parts such that the clamping member can be resiliently narrowed by means of exerting force on the fitting parts;
whereby after the front wheel has been removed from the lower ends of the main support rods, it can be held on the frame by means of hanging the hooked elements of the second connecting member on the hanging stick as well as fitting the front wheel in the holding space of the clamping member.
